(19) United States
(12) Patent Application Publication
(10) Pub. No.: US 2013/0145280 A1
(43) Pub. Date: Jun. 6, 2013

(54) Relationship Centric Mobile Interface

(71) Applicant: Jeffry Keith Green, Wainscott, NY (US)

(72) Inventor: Jeffry Keith Green, Wainscott, NY (US)

(21) Appl. No.: 13/705,871

(22) Filed: Dec. 5, 2012

Related U.S. Application Data
(60) Provisional application No. 61/567,268, filed on Dec. 6, 2011.

(51) Int. Cl. G06F 3/0484

(52) U.S. Cl. CPC G06F 3/0484
USPC 715/747

(57) ABSTRACT

A system configured to enhance a user's focus on the primary personal relationships of a user, the system comprising a utility function for a user interface designed to integrate directly into an operating system of a mobile electronic communication device. The utility function comprises a toggle allowing a user to switch between an app-centric mode and a relationship-centric mode. The relationship-centric mode allows the user to focus attention on the primary personal relationships of the user and the app-centric mode allows social interaction with every relationship of the user and access to the internet without any limitations. The utility function includes a home screen for displaying the primary personal relationships of the user. The utility function includes an individual relationship screen defining the at least one interaction modality for establishing interaction with the primary personal relationships of the user.

### RELATED APPLICATIONS

This application claims priority from the U.S. provisional application with Ser. No. 61/567,268, which was filed on Dec. 6, 2011. The disclosure of that provisional application is incorporated herein as if set out in full.

### BACKGROUND OF THE INVENTION

1. Technical Field of the Invention

The present invention relates in general to systems for user interfaces employed in mobile electronic communication devices. More specifically, the present invention relates to a system having a utility function for a user interface that enables the user to focus his or her attention on primary personal relationships.

2. Description of the Related Art

Recent years have seen massive growth of social networks such as Facebook, Google+ and Twitter in terms of both overall membership and depth of penetration into the every-day lives of the users of such systems.

Increasingly, users focus on the use of online social networks for maintaining social relations among family, friends, and among people who share their interests and/or activities simultaneously. Consumers have enthusiastically adopted the use of smartphones and other sophisticated mobile devices for accessing these social networking sites and to remain up-to-date on their social connections at nearly every waking hour. These devices have thus further increased the pervasiveness of social networks to the extent that they are deeply a part of today's society.

The extent to which such social networks and, in general, instant communication have quickly been adopted by and integrated into our society is profound. In fact, In his book iDisorder Larry Rosen, Ph.D. California State, argues that the impact on society of the digital and mobile revolution will be no less profound than the impact on the environment of global warming. In addition, Leslie Perlow Ph.D. Harvard University, author of “Sleeping with your Smartphone” addresses the issue arguing that technology marches on and there is no going back. What is needed she argues, is a concerted effort to manage the technology so it does not take over our lives. This has already occurred in the corporate world, where at some institutions it is understood that vacations and “time away” from the office are helpful to employees because of the reinvigorating effect of such time. Currently, means for effecting “time away” from a user's mobile device are limited.

Even advertisers have seen the deep entrenchment of such new means of communications. Advertisers have continually sought to monetize these social networks through the delivery of targeted advertisements, based at least in part on the massive amounts of personal information collected by these social network platforms. Additionally, some advertisers deliver targeted advertisements based at least in part on the network of social contacts (or “friends”) an individual has on the social network platform. While the advertisers have attempted to load ever more advertisements onto the mobile devices of the users of such networks, those same users have become more and more adept at ignoring the advertisements.

One downside that is emerging as more and more users become connected to the various networks, is that all current social network platforms share a significant weakness in that they tend to treat all “friends” equally. This is dramatically different from real life wherein individuals tend to categorize their relationships and distinguish between primary (strong ties), secondary (weak ties), and tertiary (casual or temporary) relationships. In real life, individuals have independent groups of friends and not a single group of 500 or more friends, which is not an uncommon number for users of such social networks.

The mechanics of existing social network platforms, in which there is a single, undifferentiated group of friends, leads to diluted/homogenized conversations and relationships. Some social networks, such as Google+ have attempted to overcome this weakness by supporting tighter groups of cohesive and coherent affiliations, or social clusters. However, these attempts have not succeeded and these ‘improved’ social network platforms still primarily support secondary and tertiary relationships.

Additionally, these efforts to overcome the weaknesses of existing social networks have presumed primary relationships to be one of those tighter groups, however, as explained below this is not always the case. An individual's primary relationships are in fact each private, and treating an individual's primary relationship like a circle of identical relationships simply does not accord with reality. Take for example the differences between the interactions an individual has with a parent, spouse, and best friend, who might all conventionally have been categorized as a “primary relationship”.

Because so many individuals access the various social networks on their mobile devices (such as mobile phones, or tablet computers), many conventional solutions utilize applications (“apps”) for these devices. There are two downsides to these conventional solutions. A first is that almost always the app is a “two way street”, meaning that the app generally requires that not only must the individual user be using the app, but each of the contacts in the app must be using the app as well. This can further complicate the above-mentioned problems in that they layer upon the user and the user's contacts yet another means for communication. The app must generally be accessed separately from the other functions of the mobile device, and are not integrated deeply to the mobile device.

Hence, it can be seen that there is a need for a system (preferably employed in a mobile electronic communication device) that allows a user to focus on the user's primary personal relationships, without the need for those individuals who make up the primary personal relationships to also be using the system. Further, such a system should include a toggle means, allowing a user to switch between an app-centric mode and a relationship-centric mode of a mobile device, wherein other features of the mobile device are still accessible by the user regardless of whether the user is in app-centric mode or relationship-centric mode. Further, the system would allow the user to cause the system to hide or deemphasize communications from non-primary relationships. Such a system would allow eventually targeted advertisements appropriate to the nature of each relationship to be delivered to the user. In addition, in such a system the user would be able to update the primary personal relationship at any time when needed.

These and other objectives, advantages, features, and aspects of the present invention will become apparent as the following description proceeds. To the accomplishment of the foregoing and related ends, the invention, then, comprises the features hereinafter more fully described, the following description and the annexed drawings setting forth in detail certain illustrative embodiments of the invention, these being indicative, however, of but several of the various ways in which the principles of the invention may be employed.

### SUMMARY OF THE INVENTION

To minimize the limitations found in the prior art, and to minimize other limitations that will be apparent upon the reading of this specification, the present invention provides a system configured to enhance a user's focus on at least one primary personal relationship of the user, and preferably a number of primary personal relationships between 1 and 9.

The present invention describes a system that comprises a utility function implemented as software or a platform on a host device, the host device preferably being a mobile communication device as further defined below. The system is defined herein as a Relationship Centric Mobile Interface (RCMI). RCMI is designed to support and enhance the user's interaction with the primary personal relationships of the user. The utility function is preferably integrated directly into an operating system of a mobile electronic communication device and includes a toggle means, allowing the user to switch between an app-centric mode and a relationship-centric mode. In alternative embodiments of the invention the system may be employed in the operating system of a mobile device. The system allows for the selection of a relationship-centric mode, which thereby allows the user to focus attention on the user's primary personal relationships without the distraction of any secondary or tertiary relationships. As a counterpart to the relationship-centric mode, the system allows for an app-centric mode, which then allows the user to interact with all of the user's relationships. The utility function allows the user to build unique integrated multifaceted interfaces that allow the user to focus on and support the user's most important relationships.

The utility function preferably includes a home screen for displaying the primary personal relationships of the user. The home screen allows the user to select individuals for interaction from the primary personal relationships displayed on the screen of the system, preferably a mobile electronic communication device such as a mobile phone or tablet computer. Although preferably the number of primary personal relationships displayed may be from between 2 and 9, less preferably the number may be between 1 and 15. The home screen may also display advertisements or targeted advertisements based on information about the user and/or the primary personal relationship of the user. In other embodiments no advertisements are displayed. The user may modify which primary personal relationships are shown at any time.

The utility function includes an individual relationship screen or relationship dashboard defining the at least one interaction modality for establishing interaction with the at least one primary personal relationship of the user. Although the number of primary personal relationships shown may be as few as one, for ease of understanding this document the term “primary personal relationships” will generally be used. This aspect allows the user to interact with the user's primary personal relationships using the at least one interaction modality displayed on the individual relationship screen. The at least one interaction modality displayed on the individual relationship screen may include but is not limited to information concerning voice calls, SMS (Short Message Service), social networking sites, file sharing, photos, videos, calendars and the like. The utility function enables the user to customize the at least one interaction modality to create a relationship-centric template. The relationship-centric template for the user's primary personal relationships appears unique depending on the types of interaction modalities more often preferred by the user to interact with the at least one primary personal relationship. The system is designed so that the mobile electronic communication device is preferably a mobile phone or tablet computer.

It is thus a first objective of the present invention to provide a system that allows a user to focus on the primary personal relationships of the user.

It is a second objective of the present invention to provide a system employed on a mobile electronic communication device that allows a user to focus on the primary personal relationships of the user.

It is another objective of the present invention to provide a system employed on a mobile electronic communication device that allows a user to easily customize the user's interactive experience to reflect the user's relationship with the primary personal relationships of the user.

It is a further objective of the present invention to provide a system employed on a mobile electronic communication device that allows a user to hide or deemphasize communication from non-primary relationships.

It is still a further objective of the present invention is to provide a system employed on a mobile electronic communication device to allow targeted advertisements to be displayed based on personal information about both the user and the primary personal relationships of the user.

These and other advantages and features of the present invention are described with specificity so as to make the present invention understandable to one of ordinary skill in the art.

### BRIEF DESCRIPTION OF THE DRAWINGS

In order to enhance their clarity and improve understanding of these various elements and embodiments of the invention, elements in the figures have not necessarily been drawn to scale. Furthermore, elements that are known to be common and well understood to those in the industry are not depicted in order to provide a clear view of the various embodiments of the invention. Thus, the drawings are generalized in form in the interest of clarity and conciseness.

FIG. 1 shows a system for maintaining focus on primary personal relationships displayed on a main screen of a mobile electronic communication device;

FIG. 2 shows a home screen of the mobile electronic communication device displaying the primary personal relationships of a user;

FIG. 3 shows an individual relationship screen or relationship dashboard defining the at least one interaction modality for establishing interaction with the primary personal relationships of the user;

FIG. 4 shows another individual relationship screen or relationship dashboard defining the at least one interaction modality for establishing interaction with the primary personal relationships of the user;

FIG. 5 shows an exemplary interaction with the primary personal relationships of the user displayed on the mobile electronic communication device;

FIG. 6 shows the home screen of the mobile electronic communication device showing a toggle switch allowing the user to toggle between the an app-centric mode and the relationship-centric mode; and

FIG. 7 shows a weather forecast and a birth date of the primary personal relationships of the user displayed on the individual relationship screen.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

The present invention describes a system configured to enhance a user's focus on that user's primary personal relationships. Although in this document the plural “primary personal relationships” is often used, it is to be understood that the system may allow as few as one personal relationship to be added, and thus the term “primary personal relationships” may be interchangeable with the term “at least one primary personal relationship”. The system comprises a utility function for a user interface designed to support and enhance the user's interaction and relationship with the user's primary personal relationships. In a preferred embodiment, the utility function is integrated directly into an operating system of a mobile electronic communication device and comprises a toggle means, thereby allowing a user to switch back and forth between an app-centric mode and a relationship-centric mode. While the toggle may be a physical button such as one located on the top, bottom or side of the phone, the toggle may also be an interactive visual representation on the screen of the device. In alternative embodiments of the invention the system may be employed in the operating system of mobile communication device, such as a mobile phone or a tablet computer. The system allows a relationship-centric mode that enables the user to focus attention on the user's primary personal relationships without the distraction seeing information provided about any of the user's secondary or tertiary relationships. The app-centric mode allows the user to interact with every relationship of the user without any limitations, and to use the mobile communication device without limitation. In an alternative embodiment of the present invention the utility function 12 is an application (software) that runs on the mobile electronic communication device.

It is important to note that what makes an individual a “primary” relationship vs. a “secondary” or “tertiary” relationship is entirely up to the user. A reasonable understanding of the terms would suggest that while primary relationships are the user's closest relationships (generally between 1 and 15, but more preferably between 2 and 9), secondary relationships may be those individuals with whom the user would consider friends, or those individuals whom the user may see on a daily basis such as at the work place. The user may define tertiary relationships as those people in the community whom the user sees from time-to-time, or individuals that are merely casual or temporary acquaintances. While these definitions help clarify the typical usage of the system, in fact the user is free to define these individuals however the user desires. Only those individuals whom the user considers to be at the primary personal relationship level need by designated to the system.

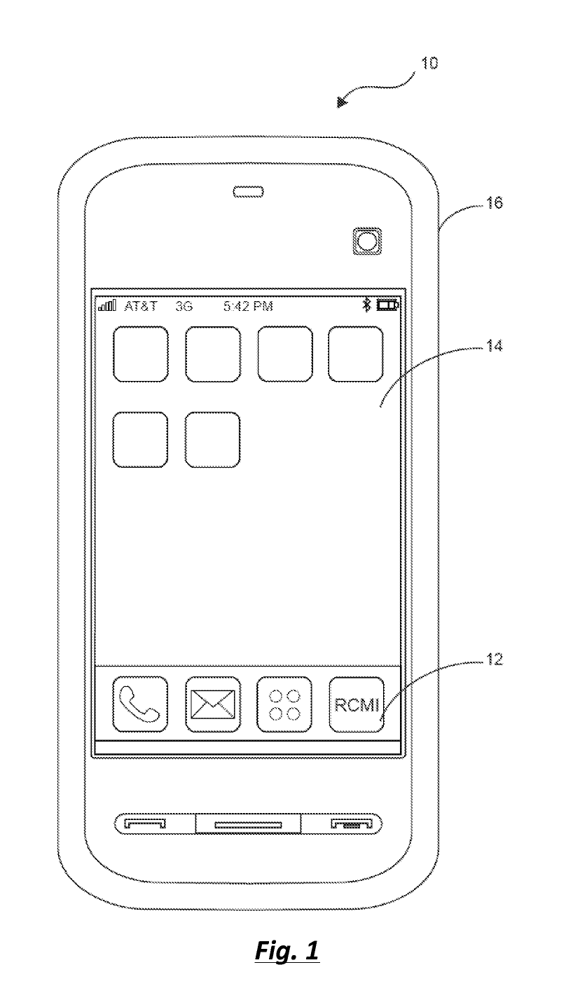

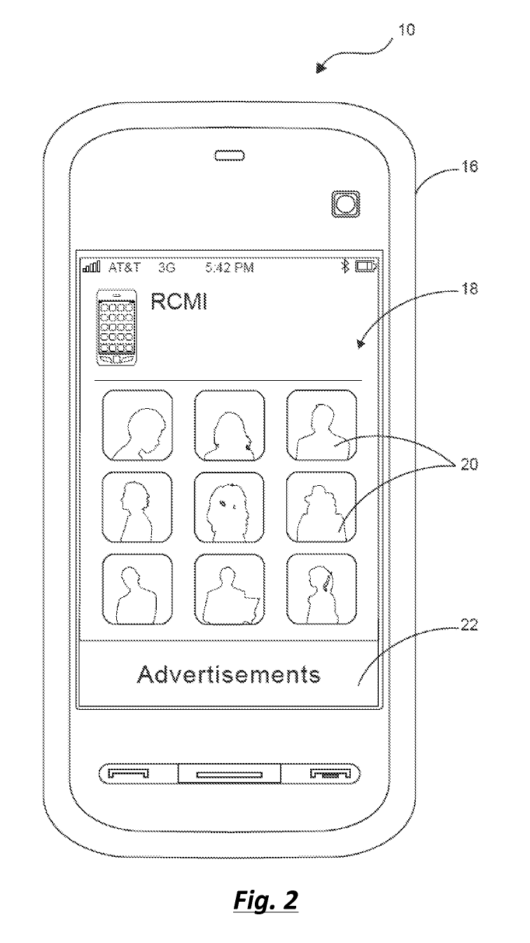

FIG. 1 illustrates a system 10 that comprises a utility function 12 defined herein as a Relationship Centric Mobile Interface (RCMI) designed to support and enhance the primary personal relationships 20 (FIG. 2) of the user and that is displayed on a main screen 14 of the mobile electronic communication device 16. The utility function 12 allows the user to build unique integrated multifaceted interfaces that allow the user to focus on and support the user's most important relationships. The utility function 12 also allows the user to “put blinders on,” that is, to hide or deemphasize incoming and outgoing communication with individuals who are not included in the primary personal relationships 20 (FIG. 2) of the user.

FIG. 2 displays an exemplary home screen 18 of the mobile electronic communication device 16 displaying the primary personal relationships 20 of the user. When the mobile device is in this mode, the app-centric mode may be entered by the user simply touching a toggle button, in this exemplary case the toggle button being the icon of a mobile phone shown near the top right edge of the screen. In this exemplary embodiment nine primary personal relationships of the user are shown. As may be seen here, the home screen 18 allows the user to select individuals for interaction from the primary personal relationships 20 displayed on the home screen 18 of the mobile electronic communication device 16. In the preferred embodiment, the home screen 18 may also display advertisements 22 or targeted advertisements based on information about the user and/or the primary personal relationships 20 of the user. The system may even understand the nature of the relationship and provide advertisements accordingly. For instance, if the personal relationship is “son” whereas the user is the “father”, then the advertisements may be targeted more to father-son relationships. Likewise, if the user and the relationship in question are both sisters, then the targeted advertisements may be targeted to that relationship. In some alternative embodiments the advertisements may be absent. The primary personal relationships 20 of a person change as he or she moves through life. That is, they are not fixed, and thus, the user may update the primary personal relationships 20 of the user at any time.

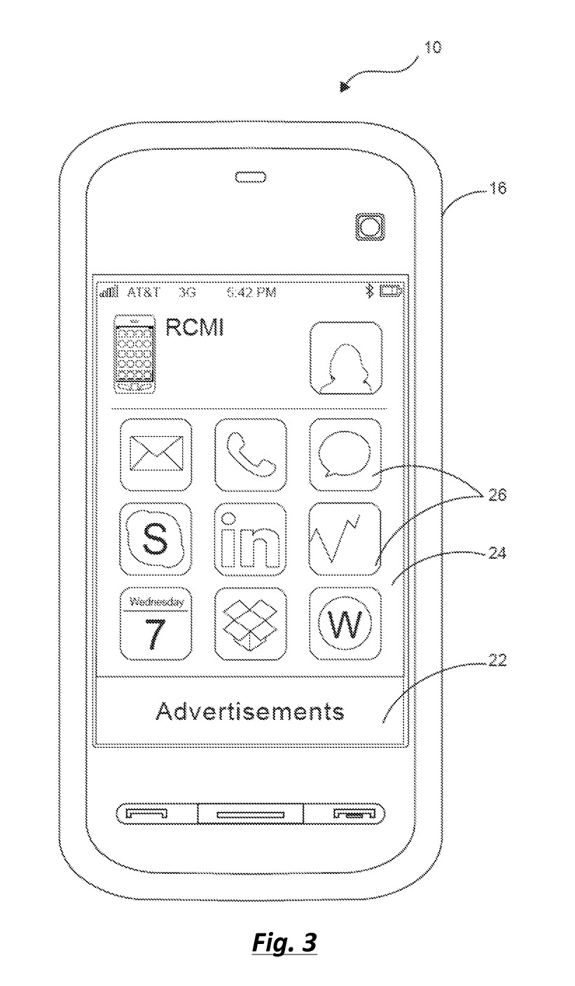

FIG. 3 shows an individual relationship screen 24 or relationship dashboard defining the at least one interaction modality for establishing interaction with the primary personal relationships of the user. This aspect provides an immediate proxy for the relationship, thereby allowing the user to interact with the primary personal relationships 20 (FIG. 2) using the at least one interaction modality 26 displayed on the individual relationship screen 24 of the mobile electronic communication device 16. Although in a preferred embodiment the system comprises at least one interaction modality 26, in alternative embodiments the system may comprise a plurality of interaction modalities. The at least one interaction modality 26 displayed on the individual relationship screen 24 includes voice calls, SMS (Short Message Service), social networking sites, a means for sharing files, photos, videos, calendars and the like. In this exemplary case, nine interaction modalities are shown. The utility function 12 (FIG. 1) enables the user to customize the at least one interaction modality 26 to create a relationship-centric template. Although the relationship-centric template for the primary personal relationships 20 (FIG. 1) appears unique depending on the at least one interaction modality 26 most often preferred by the user to interact with the primary personal relationships 20 (FIG. 1) of the user, in practice there are likely multiple modalities shown (see FIG. 3), and in one embodiment the order in which the modalities are placed is dependent on the frequency of usage of the modalities by the user. That is, the system may be a learning system which elevates those modalities more frequently used to a more prominent position on the dashboard.

The at least one interaction modality 26 is intended to encompass all possible modes/styles of interaction between individuals. The individual relationship screen 24 may also display advertisements 22 or targeted advertisements based at least in part on information on the user and the primary personal relationships 20 (FIG. 1) of the user and appropriate for the nature of that unique relationship.

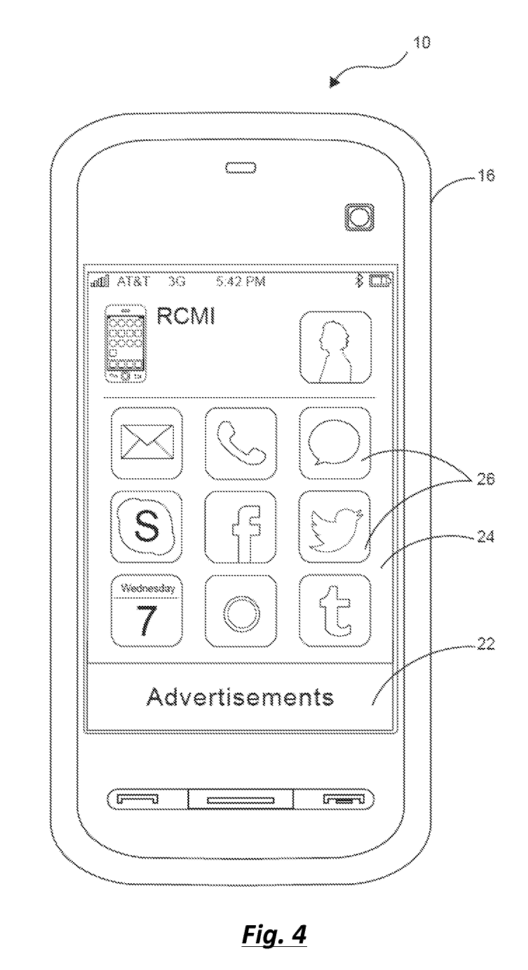

FIG. 4 shows another individual relationship screen 24 or relationship dashboard defining the at least one interaction modality for establishing interaction with the primary personal relationships of the user. As may be seen the interaction modality 26 present in the individual relationship screen 24 shown in FIG. 3 is different from that shown in FIG. 4. This reflects the fact that the utility function 12 (FIG. 1) allows the user to build unique integrated multifaceted interfaces that allow the user to focus on and support the user's most important relationships. The interface for each primary relationship may be easily customized to reflect the manner in which the user interacts with each primary relationship. The interface for the primary personal relationships 20 (FIG. 1) appears unique depending on the at least one interaction modality 26 most often preferred by the user to interact with the primary personal relationships 20 (FIG. 1) of the user. For instance, a user may interact primarily by voice call and Short Message Service (SMS) with his or her parents, but may interact substantially by instant messaging with his or her best friend.

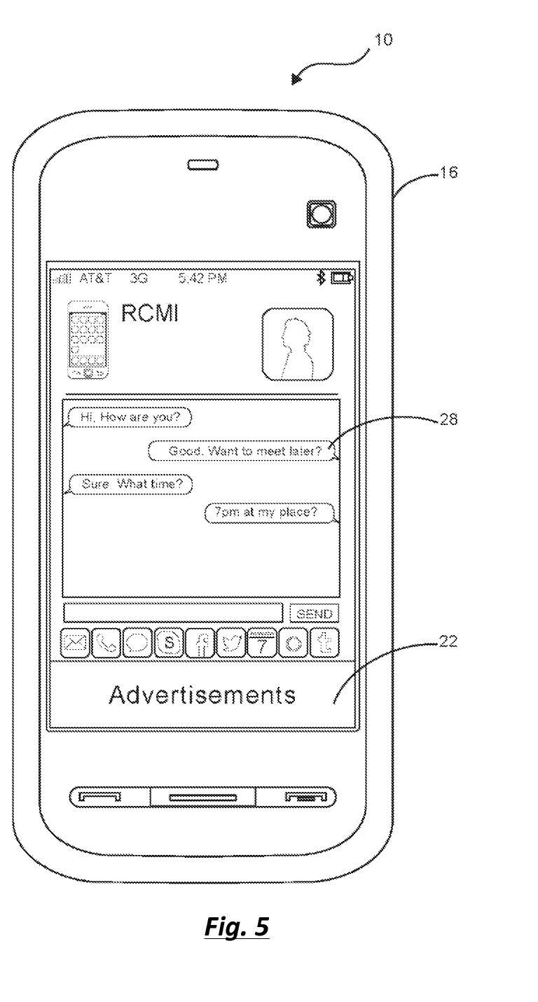

Regarding FIG. 5, a sample interaction with the primary personal relationships 20 (FIG. 1) of the user is displayed on a mobile electronic communication device 16. As may be seen, the user has selected an option for instant message 28 for interacting with the primary personal relationships 20 (FIG. 1). The user did this by selecting an instant messaging icon on the individual relationship screen 24 or relationship dashboard as shown in FIGS. 3 and 4. In the preferred embodiment, the individual relationship screen 24 may also display advertisements 22 or targeted advertisements appropriate for the nature of the at least one primary relationship of the user and/or based at least in part on information on the user and/or the primary personal relationships of the user. In some alternative embodiments the advertisements may be absent.

When the mobile electronic communication device 16 is in the relationship-centric mode, interaction with people who are not included in the primary personal relationships 20 (FIG. 1) are either hidden from the user's view entirely or otherwise accorded less importance based on a series of preferences that can be set and changed periodically by the user. Certain modes of communication, such as email and text messages are handled easily in that they are simply hidden from the user's view when messages originated from an individual who is not in the list of primary personal relationships 20. It is important to note that the messages are not blocked from receipt, but instead are merely hidden by RCMI and made inaccessible to the user until a later time when the user chooses to see them by leaving the relationship-centric mode. Other functions, such as calendar, may not be possible to modify since the user will always need to know if the user's time is already committed, even if it is to a non-primary personal relationship. (However, calendar invites from non-primary personal relationships may still be hidden while the system is in relationship-centric mode.

Also, in the relationship-centric mode, the utility function 12 is capable of alerting the user of incoming calls from non-primary-relationships with a softer or different ring tone or different vibration mode than used for incoming calls from the primary personal relationships 20 (FIG. 1). In one embodiment, the intensity alert provided by the phone about an incoming phone call is relative to the intensity of the alert globally used by the mobile device. That is, where the ring volume is set by the user to be loud, it may be quieter when representing a call from an individual not in the user's list of primary personal relationships. Similarly, when the ring volume is set to zero (vibrate mode), the intensity of the vibration may be altered or reduced when the vibration represents an incoming call from an individual not in the user's list of primary personal relationships. In some embodiments the user may elect to receive such incoming communications from non-primary relationships while the mobile electronic communication device 16 is in the relationship-centric mode, while in other embodiments the user may not be notified of such communications from non-primary relationships until the user exits the relationship-centric mode.

For instance, if the relationship-centric mode is active, the user in one embodiment is able to view only those emails from individuals included in the primary personal relationships 20 (FIG. 1) of the user, and no other e-mail is displayed. As an example, when merely wanting to check in on whether his or her family made contact, the user would not be bothered with “work emails” or other emails not sent by someone including in the primary personal relationships 20 (FIG. 1) of the user. In use, it is realized that the social networking sites may first pull all data (either from the web, app, or other suitable delivery means for data) and then apply a relevant filter as determined by the user, and display only updates from those individuals who have been included in the primary personal relationships of the user. As another example social networking sites may display only status updates from the least one primary personal relationship 20 (FIG. 1) and hide updates from non-primary relationships.

The utility function 12 aggregates all desired functions onto the relationship-centric templates or a relationship dashboard 24 as illustrated by FIGS. 3 and 4. As described above each relationship-centric template is unique and customizable. Preferably, each relationship-centric template employs the utility visual vocabulary precisely in line with the interface commonly used on each host device, preferably a mobile electronic communication device 16. Said again, the RCMI system blends in. Universality is thus a key component as well, meaning that the system is designed from the beginning to accommodate languages other than English and societal norms of a region in which a user is located or a region designated to the system by the user.

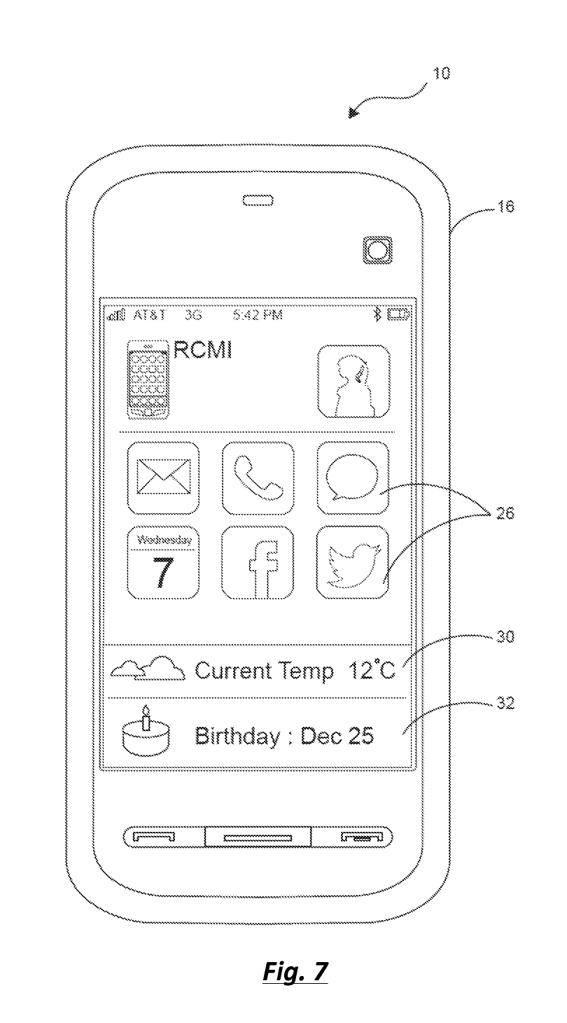

The individual relationship screen or relationship dashboard 24 may contain information about the individual the user has added. For instance, the individual relationship screen 24 is displayed by the system and contains information regarding one of the primary personal relationships of the user (in this case for the user's mother) as shown in FIG. 7. The mobile electronic communication device 16 may display weather updates 30 in the individual's city, relevant anniversaries with respect to the individual, and the birthday of the individual 32, as well as local news around the individual and other updates such as sports scores or local information relevant to the individual, such as the timing of high tide for an individual residing in a low lying coastal or island region. The universality aspect described above is also present here, in that societal norms may considered when means of interaction with the individual are presented for the user. For instance, if the individual lives in a society that does allow photographs to be received by the individual, then the system may exclude any option to send photos. With each individual relationship screen or dashboard representing specific data about the individual, the user of the system may quickly “check in” on events and information that are relative to each individual. To facilitate the quick “check in” process, the system allows the user to “swipe” from one relationship dashboard or screen to another with a left to right or right to left swipe of the figure across the screen.

The utility function 12 may aggregate other applications or interfaces into the relationship-centric templates by employing standard or specialized Application Programming Interfaces (API) or other software interfaces. There is no limit to the types of functions that may be adjusted by the system, but generally speaking, any function capable by the mobile device (including common functions as telephone, text message, email, and social networking and less common functions such as social gaming, photo streaming, friend-locator services, and Twitter access) may be included. It is to be understood that mobile devices are constantly utilizing new means of communicating with other individuals, and that the system disclosed herein is operable on all communication means with other individuals. For instance, in a word game played between an individual and four friends, when the individual places his or her mobile device in relationship-centric mode, only updates from the individual's primary relationships will be brought to the individual's attention by the game. When the individual returns his or her mobile device to app-centric mode, all updates from all four friends will become visible to the individual. As another example, many modern systems use a “Notification Center” that notifies the user of the system of any event that affects the user from any of the communication means capable by the system. When the user is in relationship-centric mode only notifications from the user's primary relationships may be displayed to the user.

In additional to the aggregating features of the dashboard, the dashboard also serves as a proxy for the individual and may include other features as well. For instance, if a mother grants her daughter access to medical files that are accessible by the system, these may be shown. Similarly, if a parent has a child that is a diabetic and the pediatric endocrinologist and/or the child has granted the parent access to a log kept by the child, then this sort of information may be included on the dashboard as well.

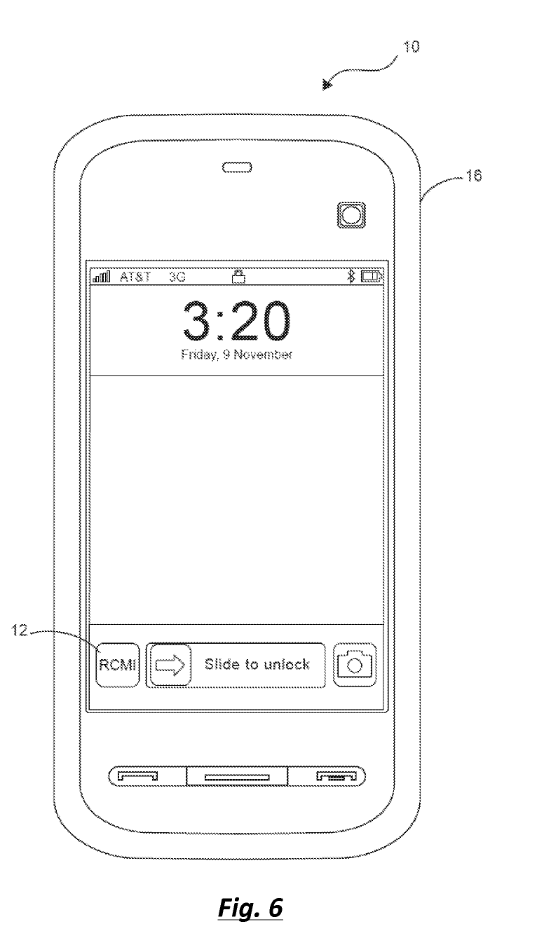

The utility function 12 may be defined as another operational mode of the mobile electronic communication device 16. For instance, a simple toggle switch for utility function 12 (in this case namely RCMI) on the mobile electronic communication device 16, as shown in FIG. 6, may allow the user to toggle between the app-centric mode and the relationship-centric mode. Optionally, the user may set a default setting which means that at startup or upon unlocking of the mobile electronic communication device 16 the utility function 12 will either be initially active each time, or initially deactivated each time. At any time the user may toggle between an app-centric mode and the relationship-centric mode.

Most of the mobile electronic communication devices 16 employ a slide to unlock mechanism. The slide to unlock mechanism prevents the unintentional use of the mobile electronic communication device 16 and requires the user to slide his or her finger either vertically or horizontally across the touch screen of the mobile electronic communication device 16. In one embodiment of the present invention wherein the invention is used in connection with mobile electronic communication devices, the user slides his or her finger from right to left to unlock the mobile electronic communication device 16 in the app-centric mode, but to activate the relationship-centric mode, the user slides his or her finger from left to right. It is to be understood that left and right swipes may also be reversed without departing from the scope of the invention. Thus, the mobile electronic communication device 16 may ideally be used in either mode from the moment the user initiates the device, but in practice the user may generally activate it at any time.

In one embodiment of the present invention, the mobile electronic communication device 16 automatically knows details regarding the location of the user, and for instance if the user is physically near any of the primary personal relationships of the user. For instance, if the user is within 15 feet of his wife (or in actuality, his wife's own mobile device), the user can set the mobile electronic communication device 16 to automatically enter the utility function so as to limit the number of interruptions received by the user while the user is with his wife.

In another embodiment of the present invention, the system provides a customizable timer for the user to automatically determine when app-centric mode and relationship-centric mode be will be entered. For instance, the relationship-centric mode may be set to automatically turn OFF during office hours. When the office time ends, the mobile electronic communication device 16 automatically enters the relationship-centric mode even if the user is still at the office.

In other embodiments, the length of time in which the system remains in either relationship-centric or app-centric mode when the mode is entered by the user overriding another mode may be modified. For instance, app-centric mode is automatically entered into by virtue of the fact that the system is being used during office hours, and the user takes a day off from the office and manually overrides the app-centric mode so as to enter relationship-centric mode, then the system may remain in relationship-centric mode until the start of the next business day. As another example, if the user is away from the office physically, the system may automatically enter relationship-centric mode based on the geographic location of the mobile device. If, when in this relationship-centric mode the user wishes to briefly enter app-centric mode to, for instance, check work emails, the system may have a timer to determine how long after the user has finished using app-centric mode that it will return to relationship-centric mode. The above timers may be as short as nearly instantaneously (meaning, in the last example that the system would immediately convert back to relationship-centric mode as soon as the user finished checking email) or any length of time beyond that, such as 15 minutes, 30 minutes, or more.

As described above certain parameters may override other parameters. As yet another example, if the user is near his wife, but he is still at office, then the fact that he is still at office overrides the function to enter the utility function based on proximity to his wife. These may also be reversed, in a situation wherein the user may set the device to automatically override changes to the system based on physical locations during set hours.

All over the above settings based on geographic location, settings based on behavior, and settings based on time (such as time of day, day of week, or whether the date is a holiday date or has special significance to the user), and timers may be set by the user in an “options” or “settings” screen displayed by the screen of the mobile device.

In yet another embodiment of the present invention, a separate device using Radio-frequency identification (RFID) or near field communication techniques may cause the mobile electronic communication device 16 to enter the utility function when the mobile electronic communication device 16 is positioned near the separate device. For instance, the user could put a near field communication facility on his or her bedroom door so that when the user passes through the bedroom door, the mobile electronic communication device 16 of the user detects that it is proximate to a near field communication area and automatically enters the relationship-centric mode. There is no need for a user to remember which messaging system he or she has used to talk to someone; instead the user may go to his or her regular email or regular text message center, and only the emails or texts from individuals who are the primary personal relationships of the user will be present for the user to review and interact with.

In yet another embodiment of the present invention, the system may provide in a very limited setting a blending of relationship-centric and app-centric mode, and only allow access to critical functions deemed by the user. For instance, one common critical function may be access to voicemail. It is known that full extraction from communication with society can bring about a certain level of anxiety in some individuals, and so to assuage that anxiety the system may allow access to only voicemail from all individuals, even if the system is in relationship-centric mode.

One advantage of the present invention is that unlike devices that require both the user and those with whom the user wishes to interact with to have the system installed on their mobile devices, the present invention is only required to be implemented or installed on the user's mobile device alone. Said again, whereas other systems are analogous to two tin cans on a string (each user needing a tin can), in the present system all benefits to the system are enjoyed by a single user of the system. The present system does not require any of the primary personal relationships of the user to do anything on their end.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. It is not intended to be exhaustive or to limit the invention to the precise form disclosed. Many modifications and variations are possible in light of the above teachings In addition, while a particular feature of the invention may have been disclosed with respect to only one embodiment, such feature may be combined with one or more other features of other embodiments as may be desired or advantageous for any given or particular application.

We claim:

1. A system comprising:
a utility function; the utility function for user interface being integrated into a mobile electronic communication device; the utility function allowing a user to switch between two modes; and the utility function being capable to customize a plurality of interaction modalities to interact with each relationship of the user.

2. The system of claim 1 wherein the utility function is designed to categorize at least one relationship based on the preference of the user.

3. The system of claim 1 wherein the utility function is designed to operate in a relationship-centric mode.

4. The system of claim 1 wherein the utility function is designed to operate in an app-centric mode.

5. The system of claim 3 wherein the relationship-centric mode allows the user to focus attention on the at least one relationship based on the preference of the user.

6. The system of claim 4 wherein the app-centric mode allows the user to interact with strong, weak and tertiary relationships and access the internet without limitations.

7. The system of claim 1 wherein a home screen displays information about the user and the at least one primary relationship of the user.

8. The system of claim 7 wherein the utility function allows the user to choose an individual for interaction from the at least one relationship displayed on the home screen.

9. The system of claim 7 wherein the utility function permits the user to update the at least one relationship displayed on the home screen at any time.

10. The system of claim 1 wherein the utility function is designed in such a way that an individual relationship screen defines the plurality of interaction modalities for establishing interaction with the at least one relationship of the user.

11. A system configured to enhance at least one relationship of a user comprising:
a utility function; the utility function for user interface being integrated into a mobile electronic communication device; the utility function comprising a toggle allowing a user to switch between two modes; and the utility function being capable to customize a plurality of interaction modalities to interact with the at least one relationship, wherein the plurality of interaction modalities of the at least one relationship varies depending on the preference of the plurality of interaction modalities chosen by the user.

12. The system of claim 11 wherein the utility function is designed to categorize the at least one relationship based on the preference of the user.

13. The system of claim 11 wherein the utility function is designed to operate in a relationship-centric mode.

14. The system of claim 11 wherein the utility function is designed to operate in an app-centric mode.

15. The system of claim 13 wherein the utility function is designed so that the relationship-centric mode allows the user to focus attention on the at least one relationship without the distraction of secondary and tertiary relationships.

16. The system of claim 14 wherein the app-centric mode allows the user to interact with strong, weak and tertiary relationships and access the internet without limitations.

17. The system of claim 11 wherein the system displays a home screen that displays information about the user and the at least one relationship of the user.

18. The system of claim 17 wherein the utility function allows the user to select individuals for interaction from the at least one relationship displayed on the home screen.

19. The system of claim 17 wherein the utility function permits the user to update the at least one relationship displayed on the home screen at any time.

20. The system of claim 11 wherein the utility function displays an individual relationship screen that defines the plurality of interaction modalities for establishing interaction with the at least one relationship of the user.

21. The system of claim 20 wherein the utility function is designed in a way that the plurality of interaction modalities displayed on the individual relationship screen includes voice calls, SMS (Short Message Service) a means for sharing files, photos, videos, calendars and the like.

22. A system configured to enhance focus on at least one primary personal relationship of a user, the system comprising:
a utility function; the utility function for a user interface being designed to integrate directly into an operating system of a mobile electronic communication device; the utility function comprises a toggle allowing a user to switch between an app-centric mode and a relationship-centric mode; wherein the relationship-centric mode allows the user to focus attention on the at least one primary personal relationship; the app-centric mode allows social interaction with every relationship of the user without any limitations and access to the internet without limitation; and the utility function being capable to customize at least one interaction modality to interact with the at least one primary personal relationship, wherein the at least one interaction modality of the at least one primary personal relationship appears unique depending upon the preference of the at least one interaction modality chosen by the user.

23. The system of claim 22 wherein the utility function is designed to categorize the at least one primary personal relationship and to distinguish strong, weak and tertiary relationships.

24. The system of claim 22 wherein the utility function may hide and/or de-emphasize incoming and outgoing communication with individuals who are not included in the at least one primary personal relationship of the user.

25. The system of claim 22 wherein the utility function displays a home screen with advertisements based on the nature of the at least one primary personal relationship of the user.

26. The system of claim 22 wherein the utility function allows the user to select individuals for interaction from the at least one primary personal relationship displayed on the home screen.

27. The system of claim 22 wherein an individual relationship screen defines the at least one interaction modality for establishing interaction with the at least one primary personal relationship of the user.

28. The system of claim 27 wherein the at least one interaction modality displayed on the individual relationship screen includes at least one of voice calls, SMS (Short Message Service), a means for sharing files.

29. The system of claim 28 wherein the utility function enables the user to customize the at least one interaction modality to create a relationship-centric template.

30. The system of claim 29 wherein the relationship-centric template for the at least one primary personal relationship appears unique depending on the at least one interactive modalities most often preferred by the user to interact with the at least one primary personal relationship of the user.

31. The system of claim 22 wherein the utility function permits the user to build a unique integrated multifaceted interface to focus on and support the at least one primary personal relationship of the user.

32. The system of claim 22 wherein when the relationship-centric mode is active an incoming telephone call received from the at least one non-primary relationship causes the system to generate a first ring tone, and an incoming telephone call received from other than the at least one non-primary relationship causes the system to either generate a second ring tone or create a notification.

33. The system of claim 22 wherein when the relationship-centric mode is active an incoming telephone call received from the at least one non-primary relationship causes the system to generate a first vibration alert, and an incoming telephone call received from other than the at least one non-primary relationship causes the system to generate a second vibration alert.
